(19) United States
(12) Patent Application Publication
(10) Pub. No.: US 2021/0225200 A1
(43) Pub. Date: Jul. 22, 2021

(54) Company Play Store and Its Operation to Realize an Educating and Entertaining Environment to Further Financial Literacy

(71) Applicant: Levada Felder, Freeport, NY (US)

(72) Inventor: Levada Felder, Freeport, NY (US)

(21) Appl. No.: 16/747,077

(22) Filed: Jan. 20, 2020

(51) Int. Cl. G09B 19/18

(52) U.S. Cl. CPC G09B 19/18; G06Q 20/12

(57) ABSTRACT

The Company Play Store (PLAY) is a retail department store operated and used by children/students. PLAY teaches children about money and finances by creating the store experience in malls (lease spaced) across the country. Students earn or purchase PLAY money to shop and parents gain a participating business specific item as change to shop again or from the participating business. The participating business specific item displays the identity of the participating business and is honored by the participating business to apply toward purchases from the participating business in an amount in real currency corresponding to the difference between the corresponding value in currency to a total of the denominations of the generic play money accepted to purchase and the corresponding value in currency to the amount of generic play money indicated as needed to make the purchase.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### BACKGROUND OF INVENTION AND RELATED ART

### The Field of the Invention

The present invention relates to the field of retail, financial literacy, play (family entertainment) for children and adults.

### Description of Related Art

Games of all types are played for entertainment. The greater the entertainment, the more popular a game becomes. However, it is long known that games not only have an entertainment value, but also have an educational value. This is true regardless of whether the game is played on a board, with cards, or on a display screen whether it is a modern digital display screen or the analogue type screens prior to the digital age.

The educational value of games, such as board games, is well known. There are unlimited examples of games which teach users various skills. Card games and various board games may teach analytical skills, creativity and deductive reasoning. Many games teach geography, history and mathematical skills. For example, games such as ‘Battleship,’ ‘Clue’ or ‘Risk’ teach analytical and deductive reasoning, basic mathematics, logic and strategy and geography. Games such as ‘Trivial Pursuit’ and ‘Scrabble’ test and hone knowledge and skills in subjects as diverse as history, geography, science, sports, entertainment, and language arts. More modern examples are games that can be played on a computer or any device with a video display screen that can challenge and teach skills in almost any subject such as science, history, trivia, sports, mathematics, computer science, etc. Indeed, simply playing such games often teach computer science skills, user interface and programming skills.

Many games require currency to play the game. That currency is provided as part of the game and is only relevant for use in the game and may be referred to as ‘play money.’ Some examples are ‘Monopoly’ and ‘Life,’ wherein players are taught skills such as how to use currency and how to purchase items with money and how to make change. Such games often teach more far-reaching skills such as balancing of finances, wealth accumulation, investing and return on investments.

The use of games as tools and aids to teach children is very well known. Schools from pre-school level to graduate and post-graduate levels make widespread use of computers such as desktops and laptops, tablets, and even cell phone type devices for educational purposes. There are games wherein children are given ‘play money’ and are then able to use the play money to purchase items as part of the game or as a reward for success. Of course, the play money has no actual value outside the confines of the game.

For many years, widespread use of the internet has made online shopping more and more popular. At present, virtually any item that can be purchased in an actual retail store can be purchased online or ‘virtually.’ It is generally known and assumed that online shopping is more popular with younger consumers than older consumers. Therefore, consumers in the Generation X and the Millennial generations do more online or virtual shopping than Baby Boomers or older generations. There is a generally held belief that consumers are purchasing less and less from the shopping malls and the retail stores and are purchasing more and more online.

In fact, younger people do not have the retail shopping experiences that those people born before the advent of the internet enjoyed. To various extents, people below the age of 20 are experiencing a vastly diminished actual retail shopping experience due to the proliferation of virtual shopping. Yet, there is evidence that people below the age 20, that is people born after 2000, do have an interest in the actual retail shopping experience and do find the actual shopping experience to be preferential to the virtual shopping experience.

The board games and the computer games referred to above, as well as others, may provide and/or enhance skills related to currency and its use and accumulation. However, the currency is not real in the sense that it cannot be used outside of the game experience. Even where the currency earned in a game can purchase a real product, such purchase and related shopping experience is not an actual retail shopping experience that goes beyond the confines of the game to an actual department store.

Given that children do, or may, have an interest in the actual shopping experience, there is a need to teach skills related to shopping, such as currency and value, to children. Moreover, rather than teaching such skills only in terms of existing board games or in relation to the virtual shopping experience, there is a need to expand upon, and combine, educational programs for students and children with their interest in the actual shopping experience. Therefore, an apparatus and methodology wherein children can accumulate currency that has an actual value which currency may then be used in an actual retail shopping experience such as at an actual department store preferably within a mall is needed. The benefits of such an invention is education for children, and adults, in terms of monetary value and use, the value, sale and acquisition of goods, and the actual shopping experience. Clearly, added benefits of such an educational learning experience include social interaction, communication skills and the health and social benefits from actual shopping at retail stores and at malls with friends, family and others. The present inventor has a website at letsplaystore.org to promote realization of such experiences.

### SUMMARY OF THE INVENTION

The “Company Play Store” is a retail department store for students which teaches students about earning, accumulating, and spending currency to acquire goods in and from an actual store. The Company Play Store is preferably several department stores in malls throughout the country. The Company Play Store is the owner of retail department stores. The stores are educational by issuing ‘play’ money to students based upon achievement. Students earn ‘play’ money that they can then use to purchase goods of their choosing that are made available at the Company Play Store retail department stores or the Company Play Store or simply the Company Play Store.

The currency is not simply ‘play’ money as one would expect to be issued as part of a conventional board game. At the outset, the Company obtains currency through various investors. The Company charges a participation fee to students, retailers, financial institutions, banks, service providers, or any individual, business or organization. Investors range from students, participating retail stores, businesses, service providers, financial institutions, banks, organizations or anyone interested in participating in the Company Play Store or in ‘playing the game.’

Students or children, either through their school, their parents or through grants pay an entrance fee, which provides them with a course in financial literacy, membership in the Company Play Store and some play money. Retailers, service providers, businesses and financial institutions (a “participant business”) pay an entrance or participation fee, which allows them to participate in the Company Play Store by selling goods or services at the store, provides them with the opportunity to have play money issued in the name of that participant (or “participating business specific play money”) which can be used to purchase goods and services at the Company Play Store or directly from the participant business. The participant business entrance and participation fees may be in part a contribution to an educational program but also, as the Company Play Store grows, a good business opportunity.

Here, the Company issues currency to students (the “play money”), based on a percentage of the student's participation or membership fee, as well as through earning the money through various achievements, such as academic or service achievements which the students can then use to purchase goods at the Company Play Store. Here, again, it is essential that the Company Play Store issue less play money in terms of the overall denominations than it has accumulated in fees, donations and other grants or investments.

The Company Play Store's currency or the play money is supplemented by further money issued in the name of businesses and other stores that participate in the Company Play Store. Retailers pay a fee to the Company Play Store to become part of the Company Play Store which allows the retailer to sell their goods at the Company stores. Each participating retailer also has currency that is issued in that retailers' name (“participating business specific play money”) which augments the play money. The participating business specific play money could be issued by the Company Play Store as change when play money is used to purchase items at the Company Play Store. The participating business specific play money is then honored at the retail stores of the Company Play Store and at participating businesses.

It should be obvious that participating retailers need not be restricted only to stores. It could include services, financial institutions, educational institutions, banks, and other goods and service providers interested in joining this unique educational experience.

An essential feature of the invention is that the Company Play Store issues play money and participating business specific play money only in total amounts which are covered by fees, grants, donations, etc. that it collects. The more investment through participation, or donations and even education, the more money available for the Company Play Store to issue play money, participating business specific play money and/or to purchase goods and services for the store or ‘stock the shelves.’ It is essential that the Company Play Store has monetary investments and fees which exceed the play money that it has issued. In this way, the play money and the participating business specific play money has an actual value in the dollar denominations indicated on the currency.

The Company Play Store preferably will have a not-for-profit status so that businesses, government agencies and charitable donors may also invest, donate or contribute to the Company Play Store. The more investment in the store, the greater the educational experience. It should be obvious that the more participation and investment, the more students that will become involved, the greater the curriculum in terms of financial literacy, business, investment and other courses that could be offered. Furthermore, as the Company Play Store grows and takes in more investment and fees, participant businesses can benefit in terms of profits on sales of goods and services.

The Company Play Store is therefore financed by the participating students and retailers who pay a membership or sponsorship fee in return for the opportunity to participate, purchase and/or sell goods or services in the Company Play Store and to issue participating business specific play money which is currency in a participating businesses own name which it then honors at its retail stores. The goal is that the Company Play Store has retail stores in malls throughout the country wherein students can shop for goods from a wide variety of retailers who participate in the store. The Company Play Store shelves may be stocked in goods and services that may have been donated or discounted, or even purchased by the Company itself. The generic play money which is generic to the Company Play Store can be used only at retail stores of the Company Play Store. The participating business specific play money can be used at retail stores of the Company Play Stores or at stores of the participating business.

Students, classes or schools (through the purchase of an age appropriate curriculum) that participate in the Company Play Stores are encouraged to earn play money, beyond that which is issued when the participation fee is paid, through academic or other achievements and then use the play money to acquire good in an actual department store. Participating retailers pay to be part of the Company Play Store with the benefit of being able to sell goods at the Company Play Stores and/or have students shop at their stores as well.

Students learn about finances, earning and spending money and are given the opportunity and encouragement to learn about and experience actual retail store shopping. The Company Play Store thus creates a real store experience in malls across the country, where students and retailers have the opportunity to join, be a part of, experience, share, learn about and promote the real department store experience.

### BRIEF DESCRIPTION OF THE FIGURES

For a better understanding of the present invention, reference is made to the following description and accompanying drawings, while the scope of the invention is set forth in the appended claims. The patent or application file contains at least one drawing executed in color. Copies of this patent with color drawings will be provided by the Office upon request and payment of the necessary fee.

FIG. 1 illustrates operation of the Company Play Store.

FIG. 2 is an isometric view of the Company Play Store.

FIG. 3 is a front view of an embodiment of the Company Play Store's play money in a denomination with the ‘Play’ logo.

FIG. 4 is a front view of a further embodiment of the Company Play Store's play money in a different denomination than that of FIG. 3.

### DETAILED DESCRIPTION OF THE INVENTION

The Company Play Store is a retail department store providing innovative learning and educational experiences for children and students under the age of 18. However, the applicability to older people and to people with learning disabilities or challenges is readily ascertainable. The Company Play Store nurtures and promotes academic, community service and other achievements through a rewarding and actual retail shopping experience and environment.

The Company Play Store teaches children/students the value of money through entertainment and education or ‘edutainment.’ The Company Play Store is an interactive retail experience designed to teach students about personal finances, customer service and entrepreneurialism through the experience of shopping. The experience of shopping begins with an understanding of how money works and how families use it to protect their financial future and then delivering that opportunity with fun.

The Company Play Store helps children learn financial literacy and to make good financial choices through actual interactive involvement with “money”. It is a “banking system” tied to a play money and/or a debit card that allows children to make financial decision as they shop through the store. This approach gives the children the opportunity to learn before they make decisions that could seriously impact their lives.

At the outset, the Company Play Store is a department store that may be preferentially located at malls across the country. However, it should be obvious that the Company Play Store may be a single store with any physical location.

Students or participants of any age pay a participation or membership fee to play the game. In return, students receive age appropriate financial literacy training and receive currency or play money (the “generic play money”) from the Company Play Store or on behalf of the Company Pay Store. Age appropriate financial literacy training include conventional financial literacy materials such as lesson plans and videos.

Educational programs beyond the basic financial literacy program requirement (a basic course a student must pass before play money is issued) are always available to students in an age and educational level appropriate environment for a fee. Additional generic play money may also be issued as part of a class, program, civic group, volunteer effort, etc. as a reward or payment for a particular achievement or service. The generic play money can then be used by the student to purchase goods or merchandise on display from the Company Play Store.

The Company Play Store may be equipped with shelves upon which is the merchandise to be purchased. The Company Play Store may also be equipped with a counter upon which is a register where transactions to purchase the merchandise on display are consummated. It is by the register where the generic play money is received from youngsters as payment for the purchase of the displayed merchandise and where change is returned for the purchase. The change is in the form of retailer specific play money or participating business specific play money. The register may resemble conventional cash registers and provide access to retrieve the participating business specific play money for returning change for purchases. The register may also accommodate storage of the general pay money that is received at the time of the purchase.

The participating business specific play money constitutes an aspect of the invention that goes beyond any board game, or any job experience, in that the participating business specific play money is used to purchase actual goods and services from an actual retail store. Unlike real money, however, the generic play money keeps the entire experience, from earning money to spending money, within the confines of the Company Play Store and the participating business specific play money extends that experience to retail stores participating in the Company Play Store. However, similar to real money, both the generic play money and the participating business specific play money have actual values equal to the denominations indicated on the currency. Therefore, it is essential that the Company Play Store only distribute generic play money and participating business specific play money in total amounts that are less than the actual amount of money it has received in fees, investments, donations, contributions, purchases, exchanges, etc.

The Company Play Store needs to attract youngsters at participating students, schools, programs, etc. and also to attract participating department or retail stores, businesses, financial institutions, banks, service providers, charitable organizations, community-based organizations, even government agencies, etc. (‘participating businesses“). Participating businesses are necessary to pay membership or participation fees, even make donations and contributions, and make their own stores available for the purchase of goods and ‘stock’ the Company Play Store with actual goods, products and services which can then be purchased or acquired with the play money. With its assets, the Company Play Store also ‘stocks’ its shelves with goods purchased directly from wholesalers or discounters, etc. The Company Play Store may have vending machines to swap real currency for play money of the Company Play Store that are analogous to conventional token vending machines that swap real currency for play tokens. ATM machines may also be made available within the Company Play Store.

One of the goals of the Company Play Store, as well as a fundamental aspect of the educational experience, is that promotion is necessary to encourage actual retail stores to be involved in the Company Play Store. Participating businesses receive many benefits for such participation. The products of participating stores are sold in the Company Play Store and the participating stores will have play money with their specific logos (“participating business specific play money”) and not just the Company Play Store's generic play money with its own logos. At the Company Play Store, when change is given after a purchase is made, the change could be in the form of any combination of play money and participating business specific play money in the denominations of the currency. Retailer specific play money can then be used to purchase products directly from the participants store as well as from the Company Play Store.

Actual products or merchandise (or goods and services) are sold in the Company Play Store or stores and the participating business specific play money is in specific denominations, whose corresponding value is honored for making purchases to the participating business. Thus, the participating business specific play money has real value to the participating businesses (identified on the participating business specific play money) and to the consumer seeking to purchase from the participating business. Moreover, since banks and financial institutions can be participants, the bank or financial institution specific play money could be converted or traded for currency such as US dollars to open bank accounts for the youngsters who acquired them from the Company Play Store. Again, to accomplish the goals herein, it is essential that the Company Play Store only issue play money and participating business specific play money in total denominations that are less than the total amount of money that the Company Play Store accumulates in fees, contributions, donations, sales, grants, etc.

It is much more than just being a participant and honoring the value of generic play money and/or participating business specific play money. The Company Play Store needs employees and it hires employees as an Equal Opportunity Employer. The employees can be paid with generic play money or participating business specific play money or actual US currency in the form of a paycheck. The denominations should all be of equal value as the stores will honor the value equally.

The play money and participating business specific play money within the network of participants, which is an ever-expanding network, preferably has the same value as US dollars. As the Company Play Store expands, and its assets in terms of goods and financial collections grows, so will the network of participating students and participating businesses. Such expansion will also grow the opportunity for students to learn and participants to realize profit.

In an example, a participating business may pay $1000 as a membership fee or as a contribution. 10% of the payment may go for the costs of printing play money and participating business specific play money, 30% to the costs associated with Company Play Store operations and maintenance including salaries, programming, utilities, rent, website maintenance, etc. 10% may go to the Company Play Store as a contribution to the preferred not-for-profit corporate parent entity. And 50% would be play money or participating business specific play money unless the participating business desires to allocate more of its fees and/or contribution to the Company Play Store for its operations.

Play money contribution allocation from Merchant
10% to Charity
25% Printing of Play Money Company Play Store
15% Cost of Contributor including printing play money; website posting (Contribution amount divided by $125=the number of posted on website
50% for Operating expenses, including salaries

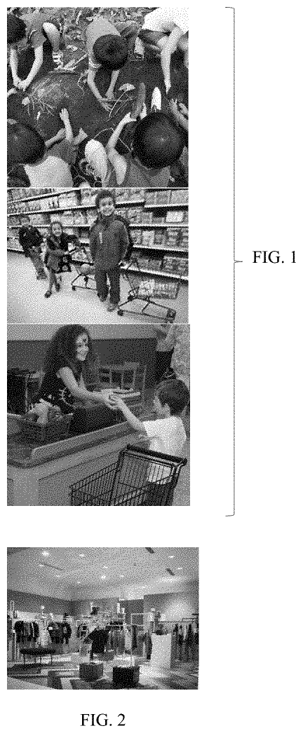

FIG. 1 is a sequential illustration of the operation of the Company Play Store. Youngsters are distributed generic play money as they successfully complete assigned tasks. Youngsters may then shop for merchandise on display in the Company Play Store and pay for the merchandise with the distributed generic play money. The merchandise on display is donated by participating businesses or paid for by participating businesses. Purchases are consummated at a counter where the youngsters give the distributed generic play money as payment for the merchandise they want to buy. A conventional cash register (not shown) will be available at the counter and the cash register will be handled for the Company Play Store and its drawer will store accepted generic play money for consummated purchases.

Change is given in the form of a participating business specific item, which is honored toward the making of future purchases from the participating business. The change is indicative of a difference in value between a corresponding total in denominations of real currency that corresponds to the denominations in the generic play money given as payment and a corresponding amount in real currency corresponding to the denominations in the generic play money that was indicated as the cost to purchase the merchandise.

The participating business specific item may be in the form of further play money that identify the participating business or in the form of conventional rewards, coupons, gift cards or debit cards from the participating business that identify the participating business and which are honored by the participating business as having monetary value that can be applied toward future purchases from the participating business.

The cash register drawer may also contain participating business specific play money to dispense as change. While drawer could contain other kinds of participating business specific items to be given as change that would be honored for future purchases from the participating business, such participating business specific items could be located elsewhere instead to be retrieved and validated, if need be, and given as change.

FIG. 2 shows an example of the one of the Company Play Stores. It is a retail store, preferably in a mall. The store accommodates children and adults. The interior of the store may be designed by interior design majors in college and be in various colors such as pink, blue, yellow, and white or any other color. The target market for the store are students in the ages 3-17. For example, children/students ages 3-13 shop (called players), receive play money in exchange for their participation fee and in reward for academic or service achievements. They can shop at the play store after fulfilling the financial literacy requirement or course. Children/students ages 14-17 also shop at the store and receive play money in the same manner as younger children/students but also as payment for working at the store in a retail customer service capacity. Therefore, the education received as part of the Company Play Store is multi-faceted. The Company Play Store is an Equal Opportunity Employer and pays at least the minimum wage appropriate.

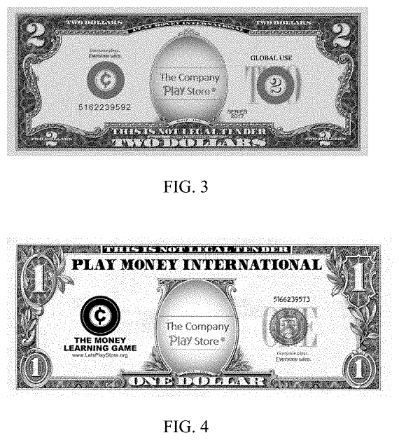

FIGS. 3-4 are examples of the play money with the Company Play Store logo to be used in purchases and sale transactions. The figures depict the play money with a Company Play Store logos or icons. In the figure, the word ‘Play’ is the icon but the logos or icons could include ‘A Money Learning Game’, ‘The Company Play Store,’ ‘Everyone plays,’ ‘Everyone Wins,’ ‘Cash In On The Fun,’ ‘letsplaystore.org,’ ‘Play Money International,’ ‘Play Money,’ ‘For Company Play Store Use Only,’ or numerous other examples which denote the currency as the play money. Likewise, the figures show the denomination of the currency, which can be in any denomination such as one, two, three, five, nine, ten, twenty, fifty, one hundred, two hundred, five hundred, etc.

The participating business specific item may be play money, which may look the same as the play money of FIGS. 3 and 4 except that the name and/or logo of the participating business would appear in place of “The Company Play Store”, which is at the center of the play money in FIGS. 3 and 4. Participating businesses could preferably include many retail stores as well as businesses, banks, institutions such as hospitals and educational facilities, etc. The figure shows that the participating business has their own logo on the play money and that such participating business specific play money can be issued directly by the Company Play Store, as change during a sale transaction at any Company Play Store, or even as change from a participating retailer. As an alternative, the participating business specific item may be instead participating business specific rewards, coupons, gift cards or debit cards could be dispensed as the change after accepting the generic play money as payment for goods or merchandise on display. Such rewards, coupons, gift cards and debit cards are conventional.

In FIGS. 3 and 4, the word ‘Play’ is the icon for the play money. The color of the icon may be any color such as blue.

In a preferred embodiment, to shop at a Play store you must be a member or associated with a member and/or a child/student. You must use the play money, or the Company Play Store's debit card and/or participating business specific play money. The membership fee is annual.

Preferably, play money is obtained by purchasing with US dollars as part of the membership or participation fee after completing the financial literacy training online or in person or after completion of curriculum learning activities online, at the local school district, or in person.

In a preferred embodiment, the Play store is stocked with common store items from designer and/or generic shoes, clothing, furniture, toiletries, school supplies, electronics, in store food stand based on negotiations made with designers, suppliers and/or manufacturers. (who are also referred to as business participants).

In another preferred embodiment, when play money is used to purchase goods at the Play store and change is required, the change is participating business specific play money with business participants logos. These business partners join by paying a fee to “cash in on the fun”. Children/Students give their parents the change or otherwise use the participating business specific play money to purchase retail items from the business participants' stores.

While the foregoing description and drawings represent the preferred embodiments of the present invention, it will be understood that various changes and modifications may be made without departing from the scope of the present invention.

1. A method of educating and entertaining within an environment, comprising:
displaying merchandise within confines of a play store;
offering age appropriate financial literacy training within confines of a play store to the youngsters;
distributing generic play money to the youngsters only after the youngsters complete the offered age appropriate financial literacy training, the generic play money having denominations corresponding to denominations in currency;
indicating an amount of the generic play money needed to make purchases of the displayed merchandise; and
consummating a purchase of the merchandise from the youngsters by accepting the distributed generic play money as payment for the merchandise and giving as change a participating business specific item,
wherein the participating business specific item differs from the generic play money in that the participating business specific item is honored when presented to a participating business as at least as partial payment toward a further purchase from the participating business and in that the participating business specific item displays an identification that is indicative of the participating business,
wherein the participating business specific item has a monetary value honored by the participating business toward the further purchase that in total corresponds to a difference in amount as between a total in the denominations in currency that corresponds to the denominations in the accepted generic play money and an amount in the denominations in currency that corresponds to the indicated amount of the distributed generic play money needed to purchase the merchandise.

2. The method of claim 1, wherein the consummating of the purchase takes place at a counter within the confines of the play store.

3. The method of claim 1, further comprising:
distributing more of the generic play money to the youngsters within confines of the play store as the youngsters successfully complete tasks.

4. The method of claim 1, further comprising:
receiving the merchandise from the participating business and then carrying out the displaying of the merchandise within confines of the play store.

5. The method of claim 1, further comprising:
accepting donations from the participating business.

6. The method of claim 1, further comprising:
selecting the participating business specific item from the group consisting of reward, coupons and gift cards that are all honored at the participating business toward further purchases from the participating business.

7. The method of claim 1, wherein the participating business specific item is further play money having denominations corresponding in value to an amount of the change.

8. A method of furthering educating and entertaining within an environment, comprising:
a participating business donating to a play store that displays merchandise within confines of a play store, offers age appropriate financial literacy training within confines of a play store to the youngsters, distributes generic play money to the youngsters only after the youngsters complete the offered age appropriate financial literacy training, indicates an amount of the distributed generic play money that is needed to purchase the merchandise, consummates a purchase of the merchandise from the youngsters by accepting the distributed generic play money as payment for the merchandise and giving as change a participating business specific item; and
honoring the participating business specific item at the participating business toward the further purchase from the participating business,
wherein the generic play money has denominations corresponding to denominations in currency,
wherein the participating business specific item differs from the generic play money in that the participating business specific item is honored when presented to the participating business as at least as partial payment toward a further purchase from the participating business and in that the participating business specific item displays an identification that is indicative of the participating business,
wherein the participating business specific item has a monetary value when honored by the participating business toward the further purchase that in total corresponds to a difference in amount as between a total in the denominations in currency that corresponds to the denominations in the accepted generic play money and an amount in the denominations in currency that corresponds to the indicated amount of the distributed generic play money needed to purchase the merchandise.

9. The method of claim 8, wherein the donating by the participating business includes the participating business donating the merchandise that is displayed.

10. The method of claim 9, further comprising:
selecting the participating business specific item from the group consisting of reward, coupons and gift cards that are all honored at the participating business toward further purchases from the participating business.

11. The method of claim 9, wherein the participating business specific item is further play money having denominations corresponding in value to an amount of the change.

12. An educating and entertaining environment, comprising:
a play store that is equipped with:
financial literacy training materials;
merchandise on display;
generic play money that designates currency denominations that corresponds to denominations in currency;
a participating business specific item that differs from the generic play money in that the participating business specific item is honored when presented to a participating business as at least partial payment toward a purchase from the participating business and in that the participating business specific item displays an identification that is indicative of the participating business; and
a counter where buying of the displayed merchandise is consummated after the generic play money is passed over the counter as payment followed by the participating business specific item being passed over the counter as change for the purchase,
wherein the participating business specific item has a monetary value when honored by the participating business toward the further purchase that in total corresponds to a difference in amount as between a total in the denominations in currency that corresponds to the denominations in the accepted generic play money and an amount in the denominations in currency that corresponds to the indicated amount of the distributed generic play money needed to purchase the merchandise.

13. The educating and entertaining environment of claim 12, wherein the participating business specific item is selected from the group consisting of rewards, coupons and gift cards that are all honored at the participating business toward purchases from the participating business.

14. The educating and entertaining environment of claim 10, wherein the participating business specific item is further play money.
